(19) United States
(12) Patent Application Publication
(10) Pub. No.: US 2005/0037256 A1
(43) Pub. Date: Feb. 17, 2005

(54) Rechargeable implantable battery pack with battery management circuit

(76) Inventor: Hiroshi Mukainakano, Valencia, CA (US)

Correspondence Address: MARY ELIZABETH BUSH;QUALLION LLC, P.O. BOX 923127, SYLMAR, CA, 91392-3127, US

(21) Appl. No.: 10/639,178

(22) Filed: Aug. 11, 2003

(51) Int. Cl. H01M 10/42; H01M 10/46

(52) U.S. Cl. 429/61; 320/112

(57) ABSTRACT

An implantable secondary battery pack having a battery management system and secondary battery is disclosed. The battery management system is capable of charging the rechargeable battery using low incoming voltage. When the rechargeable battery is charging, the battery management circuit output voltage is almost the same as that of the rechargeable battery. The battery management circuit has battery monitor functions and prevents the rechargeable battery from over-charging or over-discharging by using only one large switch. This invention can be used to remotely recharge implantable medical devices such as a pacemaker, neurostimulator, defibrillator, and cochlear implant.

### REFERENCE TO PRIOR FILED APPLICATIONS

Not applicable

### GOVERNMENT LICENSE RIGHTS

Not applicable

### FIELD

This invention relates to a power source and to a battery management system for an implantable secondary battery.

### BACKGROUND

Primary and secondary batteries each have their own strong points. For example, primary batteries can be made to have higher energy densities than secondary batteries, while secondary batteries generally provide an inherent cost savings over the life of the battery. For implantable medical devices powered by a primary battery, surgery is required to replace the device, or at least the battery, before the energy is completely drained. Because a secondary battery can be recharged from outside of a body without the patient having to undergo a surgical procedure, it is a desirable power source for implantable medical devices, increasing the patient's quality of life. However, the management system of a secondary battery is more complicated than that of a primary battery system, requiring a battery charging circuit.

Inductive charging systems for wireless charging of batteries are well known. An AC voltage is applied on a primary coil for transmitting power to a secondary coil. The incoming voltage to a secondary battery pack depends on the locations of secondary and primary coils and the distance between them. Because the secondary coil is inside the body, its specific location is not directly known. Therefore, the incoming voltage to the secondary battery is not constant, affecting secondary battery charging. Most batteries have at least a portion of their charging sequence at constant voltage. The threshold voltage required to begin charging is typically approximately the voltage of the constant voltage portion of the charging sequence. Charging can begin when incoming voltage is greater than this threshold voltage, and the battery management circuit can control the charging sequence. However, when incoming voltage is smaller than the required threshold voltage, charging cannot normally proceed. As a result, it is difficult to charge an implanted battery. To ensure charging, the primary coil has to transmit excess energy to charge the secondary battery, thereby wasting energy. Charging the secondary battery inductively requires far more energy than charging directly, using a wired system.

### SUMMARY OF THE INVENTION

In accordance with the present invention, an implantable secondary battery pack with battery management system is provided, in which minimal input voltage is required to charge the battery, thereby reducing charge time. In addition, the battery management system supplies voltage to a medical device when the secondary battery is being recharged. The output voltage to the medical device is almost the same as the secondary battery voltage and therefore can be used to identify the charge status, even when the secondary battery is not supplying current. The battery management circuit delivers charging current to the secondary battery, while monitoring the secondary battery and preventing it from over-charging and over-discharging, in such a way as to require only one large switch, thereby saving space compared to prior art systems.

### BRIEF DESCRIPTION OF THE FIGURES

FIG. 1 shows an inductive charging system of the present invention.

FIG. 2 is a timing chart of CCCV charging.

FIG. 3 is a block diagram of a first embodiment of the battery pack of the present invention showing details of the battery management circuit.

FIG. 4 shows a fixed voltage output series regulator circuit of the prior art.

FIG. 5 shows a variable voltage output series regulator circuit.

FIG. 6 shows a voltage monitor circuit.

FIG. 7 shows a voltage comparator circuit.

FIG. 8 shows operational voltage versus battery voltage of present invention.

FIG. 9 shows operational voltage versus battery voltage of a prior art system.

FIG. 10 shows a battery charging timing chart of present invention.

FIG. 11 shows battery charging timing chart of a prior art system.

FIG. 12 is a block diagram of another embodiment of an implantable secondary battery pack of the present invention.

### DETAILED DESCRIPTION

The following text describes the preferred mode presently contemplated for carrying out the invention and is not intended to describe all possible modifications and variations consistent with the spirit and purpose of the invention. The scope of the invention should be determined with reference to the claims.

Disclosed is a novel implantable rechargeable battery pack having a secondary battery and a battery management circuit that combines low operational voltage, battery protection, and battery voltage monitoring. The inventive system is used in remotely chargeable medical devices such as a pacemaker, neurostimulator, defibrillator, and cochlear implant. While this invention is effective for any kind of secondary battery, such as lithium ion, Ni—MH, and Ni—Cd, a lithium ion battery is often chosen because of its light weight and high capacity.

Preferred implementations of the present invention can charge a battery using low incoming voltage, and therefore can decrease total charging time. Furthermore, the system output voltage is approximately the same as the secondary battery voltage while the secondary battery is being charged. Therefore, battery voltage information is provided without a data line even when the secondary battery is separated from the voltage output circuit. Moreover, the system is very safe because the internal voltage monitor circuit shuts down the charger circuit when the secondary battery voltage becomes high.

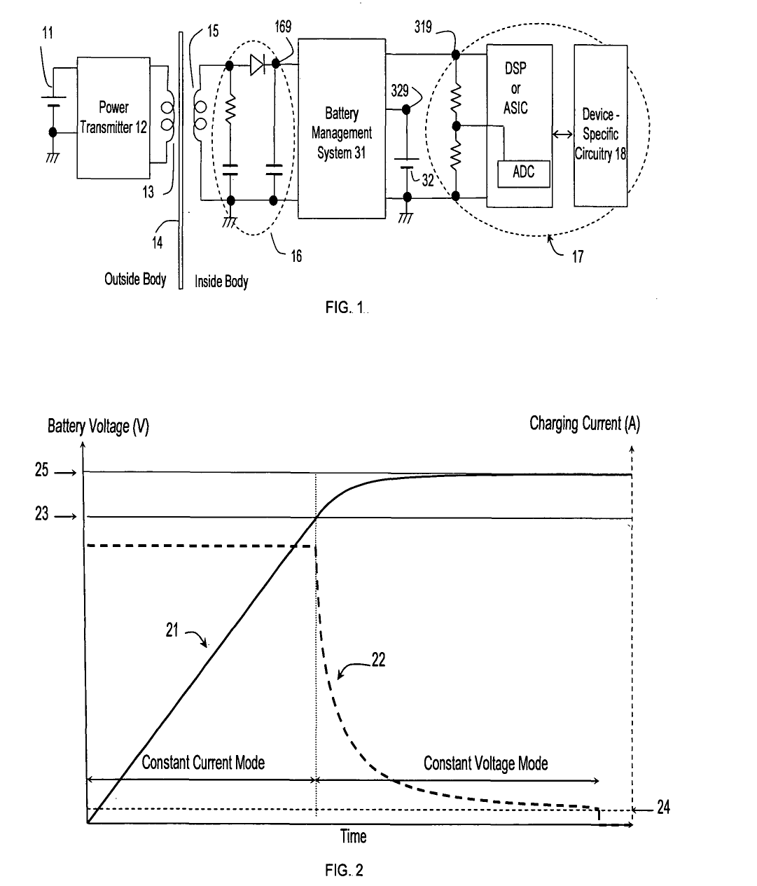

FIG. 1 shows a remote charging system of the present invention. This constant current—constant voltage (CCCV) inductive charging system can be used to charge a lithium ion secondary battery 32 used as the main power source for an implantable medical device 17. Medical device 17 may comprise a digital signal processor (DSP) or application specific integrated circuit (ASIC), and an analog to digital converter (ADC), as well as device-specific circuitry 18, as shown. Power transmitter 12 transmits energy from source 11 through primary coil 13 through the skin 14. Secondary coil 15 receives the AC voltage, which is converted to DC voltage by rectifier circuit 16. A battery management system 31 is used to control power to the secondary battery 32 and to the medical device 17 during charging of the secondary battery 32.

While nickel metal hydride and many other rechargeable batteries can use constant voltage charging, lithium ion secondary batteries must be charged by ramping up the voltage gradually, requiring a constant current source, and then a constant voltage source. In prior art charging systems, this necessitated the use of two large switches, one for controlling constant current and another for constant voltage. As will be described later, the present invention requires only one large switch.

FIG. 2 shows how the battery voltage 21 varies with the charging current 22. The charging begins in constant current mode until the battery voltage 21 reaches a certain predetermined voltage 23. Then, charging goes to constant voltage mode, charging at constant voltage with decreasing charge current 22. When the charging current 22 becomes lower than a certain predetermined value 24, the charging current 22 is cut off and the charging stops, with the battery voltage 21 at its maximally charged voltage 25, such as 4.0 V.

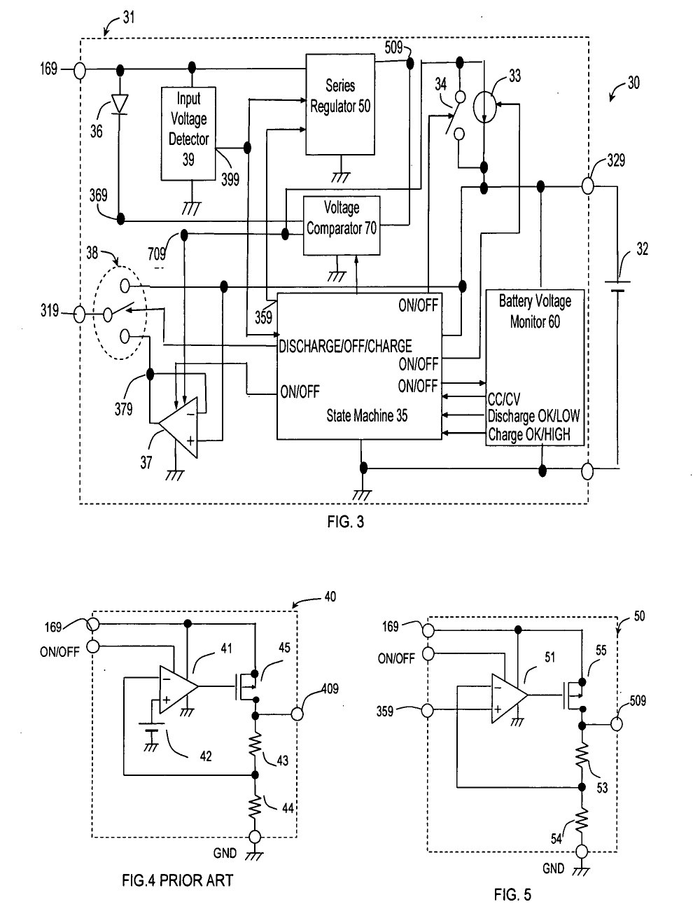

FIG. 3 is a block diagram of an exemplary embodiment of the implantable secondary battery pack 30 including battery management system (BMS) 31 and secondary battery 32. The battery management system 31 comprises circuitry functioning as a constant current source 33 for supplying constant current during the initial phase of charging. It further comprises a constant voltage source, or series regulator, 50, for charging at constant voltage. When charging is in constant current mode, the constant voltage source 50 is on “standby”, and switch 34 is prepared to switch to the constant voltage source when appropriate by reducing resistance between constant voltage source 50 and the secondary battery 32. State machine 35 controls the switch 34 for selecting between constant current mode and constant voltage mode depending on the secondary battery voltage and current as determined either directly from terminal 329 or from a battery voltage monitor 60.

FIG. 4 shows a typical fixed voltage output series regulator 40 used in prior art battery management systems, which comprises a voltage comparator 41, voltage reference 42, first resistor 43, second resistor 44, and a field effect transistor 45. The output of constant voltage source 40 is controlled by values of voltage reference 42, first resistor 43, and second resistor 44. These values can be selected and fixed by design to produce a desired constant voltage output at terminal 409; alternatively, resistors 43 and 44 can be variable resistors and/or voltage reference 42 can be a variable voltage reference, to provide an adjustable output at terminal 409. If the battery management system input voltage 169 is high enough for constant voltage mode operation, prior art charging systems that use such a fixed voltage output series regulator can be used, such as the one taught in U.S. Pat. No. 6,184,660 to Hatular, which uses an AC adapter for an external power source. In that case, the power supply voltage is constant at 5 V and is very stable during battery charging mode. However, as discussed above, the incoming voltage for an implanted device is generally unstable. Since the voltage received by the secondary coil strongly depends on distance, angle, and size of the primary and secondary coils, when distance and angle are fixed, the secondary coil can get very stable voltage, similar to using regulated constant voltage for input. But if the two coils are moved father apart, voltage decreases dramatically. If the battery management system voltage input does not meet the threshold voltage required to operate the series regulator to provide constant voltage, the secondary battery is not charged at all.

To solve the problem of charging with varying and low input voltage, the inventive battery management system 31 shown in FIG. 3 comprises a variable voltage output series regulator 50 and a voltage comparator 70. Diode 36 protects reverse current flow from the secondary battery 32 to the incoming power source, and typically has a forward voltage of 0.6 V. Note that diode 36 can be replaced with other components for preventing reverse current flow, such as two switches and a control circuit, as would be apparent to one skilled in the art. As will be explained below, the battery management system 31 can begin charging the secondary battery 32 when the BMS input voltage 169 is greater than the secondary battery voltage 329 by the amount of the forward voltage 369 of diode 36.

FIG. 5 shows a variable voltage output series regulator 50 used in the present invention, comprising a voltage comparator 51, first resistor 53, second resistor 54, and field effect transistor 55. The variable voltage output series regulator voltage at terminal 509 changes in proportion with the output voltage from state machine 35 at terminal 359.

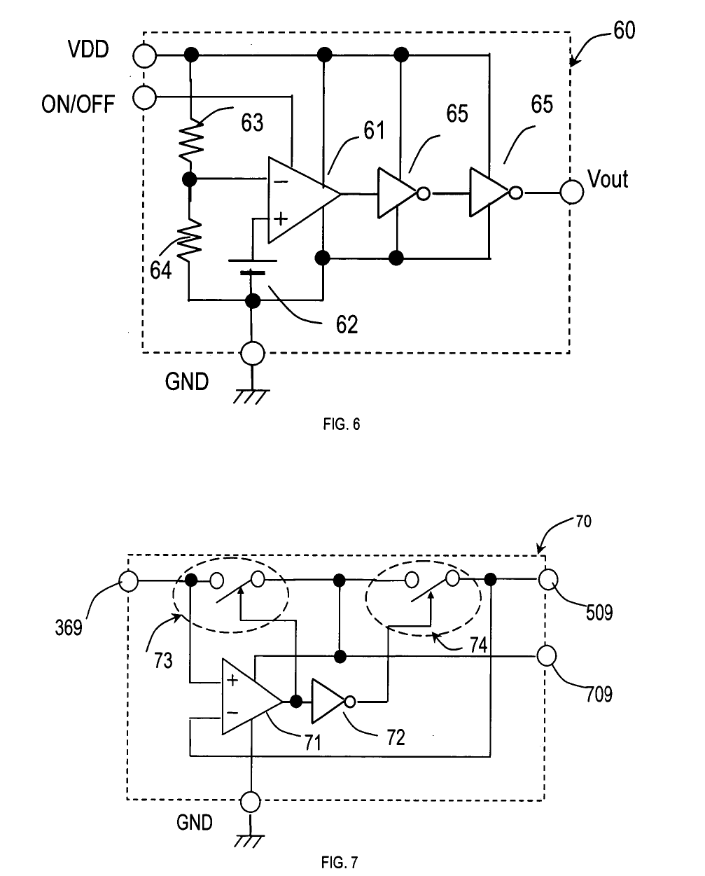

FIG. 6 shows an example of the circuit that can be used for input voltage detector 39. When adequate input voltage 169 is detected, the voltage at 399 turns on the series regulator 50 and tells state machine 35 to tell voltage comparator 70 to output voltage 509 at terminal 709, as shown in FIG. 3. The voltage level required to turn on the series regulator varies with the type of secondary battery 32 and specific embodiment of battery management system 31, but is typically about 4.5 to 4.6 V for lithium ion batteries. Setting the voltage at 709 equal to that of terminal 509 when the voltage level required to turn on the series regulator is reached ensures that only regulated voltage is used to power the device at 319.

FIG. 7 shows an example of a voltage comparator circuit, which comprises a voltage comparator 71, inverter 72, first switch 73, and second switch 74. The voltage comparator circuit compares the voltages at terminals 369 and 509, determines which one is higher, and outputs the higher voltage of the two at terminal 709, unless told by the state machine 35 that 709=509, as described above.

As shown in FIG. 3, a battery voltage monitor circuit 60 is connected with the secondary battery 32 to continuously monitor its voltage 329 and sends a signal to a state machine 35 to control the battery voltage to avoid temperature increases from over-charging and cycle life decreases from over-discharging. The battery voltage monitor 60 provides information as to whether the secondary battery voltage is OK to discharge or too low (LOW), typically about 2 V, and should therefore stop discharging; it also provides information as to whether the secondary battery is less than fully charged and therefore OK to charge, or fully charged (HIGH), typically 4.2 V, and should therefore stop charging. The battery voltage monitor 60 also provides information as to whether the secondary battery has reached the voltage at which it should switch from constant current to constant voltage mode. The state machine, in turn, operates switch 38 to allow or disallow charging or discharging, and operates switch 34 to select constant current or constant voltage charging mode.

The circuit shown in FIG. 6 converts the analog battery voltage 329 into a digital signal; three such circuits can be used by battery voltage monitor 60 to provide OK to discharge and OK to charge information and charging mode selection. The circuit of FIG. 6 comprises a voltage comparator 61, voltage reference 62, first resistor 63, second resistor 64, and two inverters 65. The detection voltage Vout is determined by the values of voltage reference 62, first resistor 63, and second resistor 64. While FIG. 6 is shown having two inverters to convert the battery voltage 329 to a digital signal to provide information to the state machine 35 to stop or allow charging and to stop or allow discharging and select charging mode, it will be readily understood that a buffer could be used for this purpose. It will also be readily understood that using alternative circuitry, battery voltage monitor 60 could provide an analog voltage to state machine 35, from which the state machine could determine whether to allow battery charging or discharging to continue and charging mode selection.

When the secondary battery 32 in FIG. 3 is being charged, it does not supply current except to battery voltage monitor circuit 60. In this mode, switch 38, which is controlled by state machine 35, connects battery management system output terminal 319 with the amplifier 37 powered by voltage comparator 70. Because the voltage of output terminal 319 is almost the same as the secondary battery voltage 329, differing only by a small constant (the offset voltage of amplifier 37, typically 10 mV), it provides useful information regarding the charging status while charging; once the battery is fully charged, the output terminal voltage is constant. (Note that although amplifier 37 is shown used as a voltage follower in this example, it may alternatively be incorporated in a positive gain circuit.) In contrast, prior art systems output constant voltage during charging of the secondary battery, therefore requiring an extra wire to send battery voltage information, occupying extra space and consuming current.

When battery voltage becomes higher than a certain voltage, the voltage monitor 60 signals the state machine 35 to turn off power to both the current source 33 and switch 34, causing the system to stop charging the secondary battery. If the power supply is still connected, switch 38 keeps battery management system output 319 connected to amplifier 37. If the power supply is disconnected, switch 38 disconnects terminal 319 from amplifier 37. While prior art charging systems require a large switch on the order of 5 mm or greater for controlling charge current, such a large switch is not necessary for the present invention.

When the secondary battery 32 in FIG. 3 is discharging, it supplies current to a few circuits. The secondary battery 32 powers state machine 35. State machine 35 controls switch 38 to connect output terminal 319 with secondary battery 32 at terminal 329. When the secondary battery 32 supplies energy, amplifier 37 is turned off by the state machine 35 to conserve energy.

When battery voltage becomes lower than a predetermined voltage, to avoid overdischarging, the voltage monitor 60 signals the state machine 35 to control switch 38 to disconnect terminal 319 from all components, causing the secondary battery to stop discharging. At that low voltage, the state machine 35 also turns off the battery voltage monitor 60 to conserve energy and avoid overdischarging the battery 32.

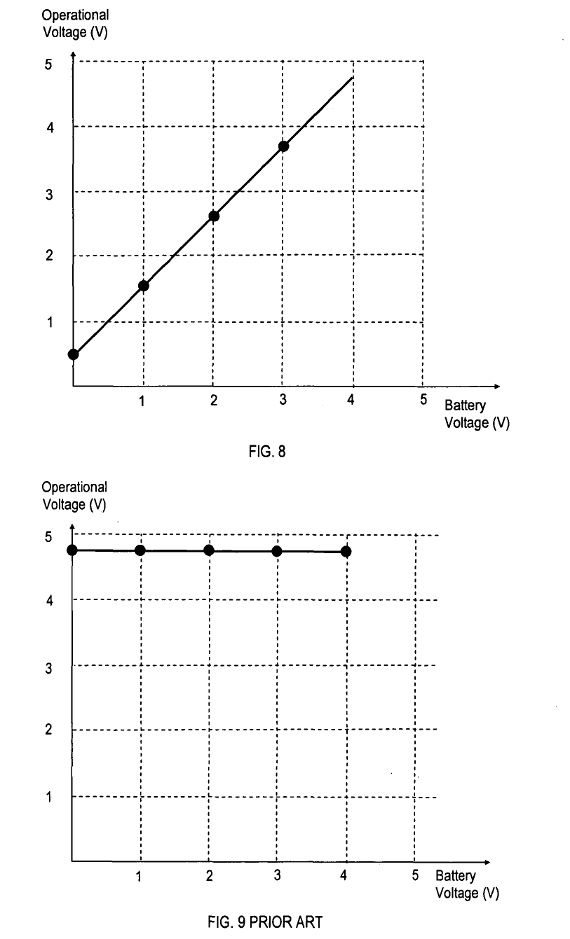

As shown in FIG. 8, the battery management circuit of the present invention can charge the battery from low incoming voltage. The term “operational voltage” is used to denote the lowest incoming voltage for which charging will occur for a given secondary battery voltage. Voltage comparator 70 is key to providing charging as long as the incoming voltage is slightly higher than that of the secondary battery. A 0.6 V voltage difference between the incoming voltage and, the secondary battery voltage is generally necessary because of forward voltage of diode 36. For example, a secondary battery that has dropped to a voltage of 1.0 V can be charged by 1.6 V incoming voltage. Other diodes having a smaller forward voltage, such as a Schottky diode having a 0.25 V forward voltage, can be used and require less of a difference between the incoming voltage and the secondary battery voltage.

In contrast, as shown in FIG. 9, the battery charger of the prior art needs more than 4.7 V for incoming voltage even when the secondary battery voltage is only 1.0 V.

FIG. 10 shows a hypothetical example of a battery charging timing chart of a system of the present invention, showing the secondary voltage response to a changing battery management system (BMS) input voltage 169. Both the secondary battery voltage 329 and the BMS input voltage 169 are initially zero at time 101. The BMS input voltage 169 is increased, with charging of the secondary battery 32 beginning to occur at time 102 when the BMS input voltage is higher than the forward voltage of diode 36, in this example, 0.6 V. When the BMS input voltage reaches 2 V at time 103, the charging is switched to constant voltage, and is held at 2 V. Once the battery voltage reaches 0.6 V less than the BMS input voltage at time 104, the battery voltage also becomes constant. At time 105, the charging voltage is gradually reduced, and charging stops. The BMS input voltage is reduced to 1 V, and then increased to 3 V. Charging resumes at time 106 when the BMS input voltage again becomes 0.6 V higher than the battery voltage. After reaching 3 V, the BMS input voltage is again held constant and the battery voltage allowed to plateau. At time 107 the BMS input voltage is increased, this time to a preset voltage of 5 V at time 108, at which point switch 34 responds to state machine 35 to move the charging to constant voltage mode. The battery is fully charged at time 109, at which time charging stops. Note that had the preset voltage been 4.6 V instead of 5 V, the resulting battery voltage would have been the same due to the maximum voltage obtainable by the battery, typically 4.0 to 4.1 V for lithium ion batteries.

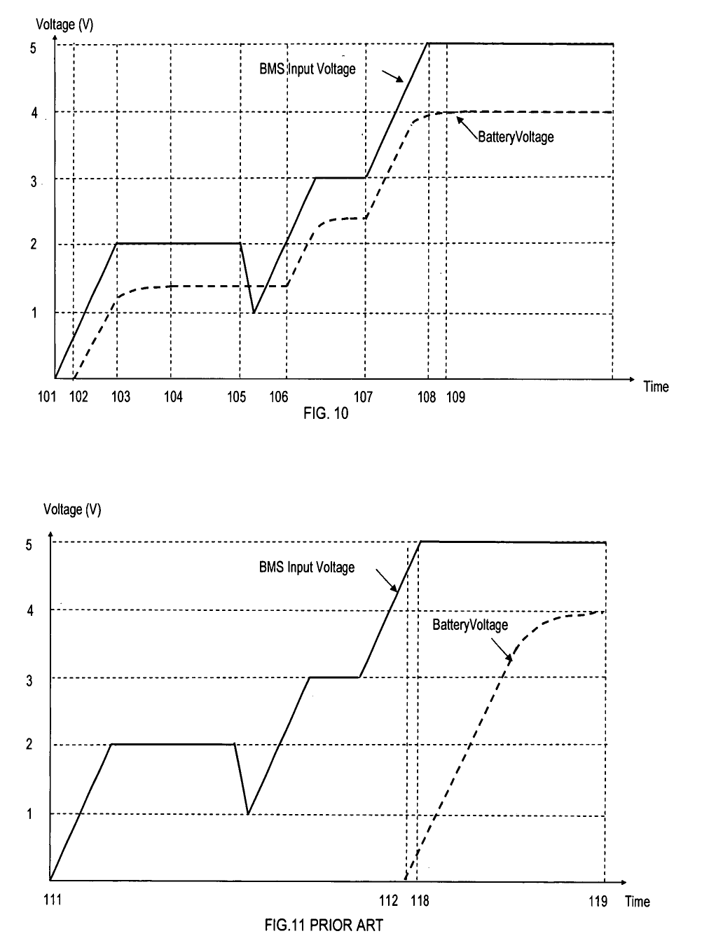

In contrast, FIG. 11 shows a prior art battery voltage response to the same charging sequence described above. Again, both the BMS input voltage and the secondary battery voltage are initially zero at time 111. Unlike the inventive system, charging does not begin until the BMS input voltage is at least 4.7 V at time 112. The BMS input voltage shown initially until time 112 cannot be used to charge the battery. Charging begins when the BMS input voltage becomes higher than 4.7 V at time 112, and charging automatically switches to constant voltage mode when the BMS input voltage reaches a preset voltage, in this case, 5 V at time 118. The battery reaches its maximum voltage and the charging procedure finishes at the time 119.

As will be readily apparent, the charging time of this invention is faster than that of the prior art because this invention allows charging at lower input voltage, using incoming energy efficiently by not wasting energy that is provided that is too low voltage for prior art chargers. Furthermore, the present invention output voltage is very close to battery voltage, providing information regarding the battery charging condition without requiring extra terminals or wires. Moreover, the system provides added safety because the internal voltage monitor automatically controls charge and discharge, depending on secondary battery voltage.

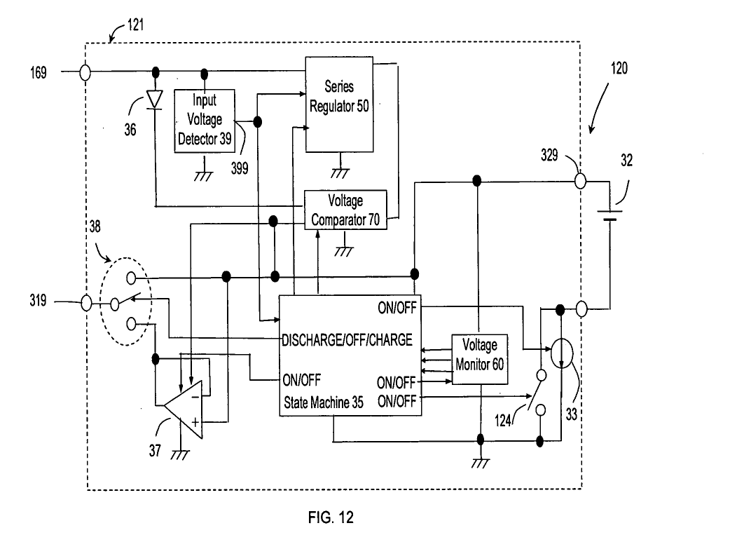

FIG. 12 is a block diagram of another exemplary embodiment of the implantable secondary battery pack 120 including a battery management system 121 and secondary battery 32. In this case, the current source is connected with the secondary battery negative side. By using this embodiment, an N channel transistor can be used for the large switch 124. Generally an N channel transistor has half the resistance of a P channel transistor, and therefore can be made half the size of a P channel transistor, conserving space, which can be at a premium in implantable devices.

While the invention has been described for use with an implantable battery, the inventive battery management system has wider application. Any inductive charging system wherein coil proximity can vary may be improved by the present invention. Furthermore, embodiments of this invention can find wider application in noninductive charging systems. For example, this invention can be used in any application in which the input voltage to the charger varies, such as from solar power or other varying supply voltage.

The specific implementations disclosed above are by way of example and for enabling persons skilled in the art to implement the invention only. We have made every effort to describe all the embodiments we have foreseen. There may be embodiments that are unforeseeable and which are insubstantially different. We have further made every effort to describe the methodology of this invention, including the best mode of practicing it. Any omission of any variation of the method disclosed is not intended to dedicate such variation to the public, and all unforeseen, insubstantial variations are intended to be covered by the claims appended hereto. Accordingly, the invention is not to be limited except by the appended claims and legal equivalents.

1. A secondary battery pack for powering a device, comprising:
a secondary battery having a secondary battery voltage; and
a battery management system electrically coupled to said secondary battery; said battery management system comprising:
an input for receiving a battery management system input voltage from a charging source; and
a component that prevents reverse current flow from said secondary battery to said charging source, said component having a forward voltage; wherein
said secondary battery voltage increases when said battery management system input voltage is greater than said secondary battery voltage by said forward voltage.

2. The battery pack of claim 1 wherein said input comprises:
a secondary coil.

3. The battery pack of claim 1 wherein said input comprises:
a socket for accepting an output of a charging source.

4. The battery pack of claim 1 wherein said battery management system further comprises:
means to supply voltage to medical devices when said secondary battery is being recharged.

5. The battery pack of claim 1 wherein said battery management system can deliver charging current to the secondary battery while monitoring the secondary battery and preventing said secondary battery from over-charging and over-discharging, and wherein said battery management system has only one large switch.

6. The battery pack of claim 1 wherein:
the output voltage to the device is almost the same as said secondary battery voltage and can be used to identify the charge status.

7. The battery pack for powering a device, comprising:
a secondary battery having a secondary battery voltage; and
a battery management system electrically coupled to said secondary battery; wherein
the output voltage to the device is almost the same as said secondary battery voltage and can be used to identify the charge status of said secondary battery.

8. A secondary battery pack for powering a device, comprising:
a secondary battery having a secondary battery voltage; and
a battery management system electrically coupled to said secondary battery; said battery management system comprising:
an input for receiving a battery management system input voltage from a charging source;
a component for preventing reverse current to said charging source, said component having a voltage drop;
a variable output voltage series regulator circuit having a regulator output voltage;
a voltage comparator for comparing said battery management system input voltage minus said voltage drop to said regulator output voltage and outputting the higher of said battery management system input voltage minus said voltage drop and said regulator output voltage; wherein
said secondary battery voltage increases when said battery management system input voltage minus said voltage drop is greater than said secondary battery voltage.

9. The battery pack of claim 8 wherein said input comprises:
a secondary coil.

10. The battery pack of claim 8 wherein said input comprises:
a socket for accepting an output of a charging source.

11. The battery pack of claim 8 wherein said battery management system further comprises:
means to supply voltage to medical devices when said secondary battery is being recharged.

12. The battery pack of claim 8 wherein said battery management system can deliver charging current to the secondary battery while monitoring the secondary battery and preventing said secondary battery from over-charging and over-discharging, and wherein said battery management system has only one large switch.

13. The battery pack of claim 8 wherein said battery management system further comprises:
a constant current source circuit; and
a switch to select between constant current and constant voltage charging mode.

14. The battery pack of claim 8 wherein:
the output voltage to the device is almost the same as said secondary battery voltage and can be used to identify the charge status.
